(19) United States
(12) Patent Application Publication
(10) Pub. No.: US 2008/0288866 A1
(43) Pub. Date: Nov. 20, 2008

(54) MOBILE DEVICE CARROUSEL SYSTEMS AND METHODS

(76) Inventors: James H. Spencer, Tucker, GA (US); Ian Klein, Logsville, GA (US); Garey C. Kennebrew, Suwanee, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/749,785

(22) Filed: May 17, 2007

(51) Int. Cl. G06F 3/02; H04M 1/00; H04M 3/42

(52) U.S. Cl. 715/716; 455/414.1; 455/566

(57) ABSTRACT

Receiving a first plurality of media presentations; outputting the first plurality of media presentations to a user of a mobile telephone in a first sequential presentation of the first plurality of media presentations at least until the user selects one of the first plurality of media presentations; outputting a second sequential presentation of the first plurality of media presentations to the user if the user does not select a media presentation during the first sequential presentation of the first plurality of media presentations; receiving a first user input corresponding to a first selected media presentation among the first plurality of media presentations; and outputting at least a first media item corresponding to the first selected media presentation responsive to receiving the first user input.

### BACKGROUND OF THE INVENTION

Mobile telephones are currently configured to provide audio and/or video presentations (e.g., music and/or music videos) to users. Mobile telephone menus for selecting audio and/or video presentations are currently not sufficiently descriptive of the corresponding audio and/or video items. For example, current menus are in the form of text lists. Therefore, using such mobile telephone menus can be unappealing to mobile telephone users.

Furthermore, with the expanding capabilities of mobile telephones, and the increasing need in the art to improve the safe operation of the same—especially while the user is operating heavy machinery—such as an automobile, there is a need in the art for improving the user interface of a mobile telephone for any user to mobile phone interaction. One of the big steps forward in meeting this need in the art is voice activated dialing. Such technology allows a user to dial a number without ever having to take his or her eyes off of the road. However, when the mobile telephone is presenting information back to the user, such as presenting menu selections, voice mail retrievals, email retrievals, etc., the user is often required to look at and navigate a text based menu interface. What is needed in the art is an interface that enables user to navigate through various interface functionalities without having to look at the display.

### SUMMARY

The present invention is directed towards a user interface for a mobile telephone or other mobile device that not only presents content in a safe manner, but that also takes advantage of the advanced technological capabilities of state of the art mobile devices. In general, one embodiment of the present invention provides a carrousel-like menu structure for navigating and/or accessing multimedia content or other content. Each carrousel includes one or more items that may be of uniform or varying content formats. For instance, the content could be audio, video, still frames, ring tones, wall paper, etc. or two or more of these and other formats. When the user accesses the carrousel, the items are presented in a cyclical fashion to the user until the user either makes a selection or performs some other action to alter the cyclical presentation, such as fast forwarding, going back, etc. The items in the carrousel may represent a vector or access point to another carrousel, or may represent an access to specific media content. For instance, an entry in the carrousel may be the name of a professional music artist. Selecting that artist may result in delivering the artist's latest hit or, may result in providing a second carrousel that includes various items associated with the artist, such as songs, ring tones, wallpapers, etc.

An embodiment of a method for providing media presentations includes: receiving a first plurality of media presentations; outputting the first plurality of media presentations to a user of a mobile telephone in a first sequential presentation of the first plurality of media presentations at least until the user selects one of the first plurality of media presentations; outputting a second sequential presentation of the first plurality of media presentations to the user if the user does not select a media presentation during the first sequential presentation of the first plurality of media presentations; receiving a first user input corresponding to a first selected media presentation among the first plurality of media presentations; outputting at least a first media item corresponding to the first selected media presentation responsive to receiving the first user input.

An embodiment of another method for providing media presentations includes: transmitting a first plurality of media presentations to a mobile telephone, wherein the first plurality of media presentations are presented by the mobile telephone to a user of the mobile telephone in a first sequential presentation of the first plurality of media presentations at least until the user selects one of the first plurality of media presentations via the mobile telephone, and wherein a second sequential presentation of the first plurality of media presentations is output by the mobile telephone to the user if the user does not select a media presentation via the mobile telephone during the first sequential presentation of the first plurality of media presentations; receiving from the mobile telephone a first selection signal corresponding to a first selected media presentation among the first plurality of media presentations, wherein the first selection signal is transmitted by the mobile telephone responsive to a first user input selecting the first selected media presentation; and transmitting to the mobile telephone at least a first media item corresponding to the first selected media presentation among the first plurality of media presentations responsive to receiving the first selection signal, wherein the mobile telephone receives the first media item and provides the first media item to the user.

An embodiment of system for providing media presentations includes: software and hardware configured to enable a mobile telephone to: receive a first plurality of media presentations; output the first plurality of media presentations to a user of the mobile telephone in a first sequential presentation of the first plurality of media presentations at least until the user selects one of the first plurality of media presentations; output a second sequential presentation of the first plurality of media presentations to the user if the user does not select a media presentation during the first sequential presentation of the first plurality of media presentations; receive a first user input corresponding to a first selected media presentation among the first plurality of media presentations; and output at least a first media item corresponding to the first selected media presentation responsive to receiving the first user input.

An embodiment of another system for providing media presentations includes software and hardware to enable at least one server to: transmit a first plurality of media presentations to a mobile telephone, wherein the first plurality of media presentations are presented by the mobile telephone to a user of the mobile telephone in a first sequential presentation of the first plurality of media presentations at least until the user selects one of the first plurality of media presentations via the mobile telephone, and wherein a second sequential presentation of the first plurality of media presentations is output by the mobile telephone to the user if the user does not select a media presentation via the mobile telephone during the first sequential presentation of the first plurality of media presentations; receive from the mobile telephone a first selection signal corresponding to a first selected media presentation among the first plurality of media presentations, wherein the first selection signal is transmitted by the mobile telephone responsive to a first user input selecting the first selected media presentation; and transmit to the mobile telephone at least a first media item corresponding to the first selected media presentation among the first plurality of media presentations responsive to receiving the first selection signal, wherein the mobile telephone receives the first media item and provides the first media item to the user.

Other systems, methods, features, and advantages of the present invention will be or become apparent to one with skill in the art upon examination of the following drawings and detailed description. It is intended that all such additional systems, methods, features, and advantages be included within this description, be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a block diagram depicting an embodiment of a communication system.

FIG. 1B is a block diagram depicting another embodiment of a communication system.

FIG. 1B is a block diagram depicting carrousel presentations being stored outside a media server.

FIG. 2 is a diagram depicting an embodiment of a carrousel.

FIG. 3 is a diagram depicting an embodiment of a carrousel system.

FIG. 4 is a flow chart depicting a method for providing media to a mobile telephone.

FIG. 5 is a flow chart depicting a method for providing media to a mobile telephone.

FIG. 6 is a block diagram illustrating an embodiment of an application server.

FIG. 7 is a block diagram illustrating an embodiment of a media server.

### DETAILED DESCRIPTION

According to one embodiment, audio and/or video presentations are provided to a mobile telephone user as a carrousel presentation. Each item in a carrousel presentation is played in sequential order until all items are played or until an item in the carrousel is selected by a user. If no item is selected by the user while the items are initially presented, then the carrousel application will replay the items, beginning with the first item, and so on, until a selection is made by a user.

The items displayed via a carrousel can include a wide variety of media, such as, for example:
video clips (e.g., selected excerpts from a video production);
moving graphics, such as item names, with related or unrelated audio background;
demo clips (screen captures of games, video ring-tones, wallpapers, etc.);
audio (music, audio-only ring-tones, etc.)
audio and/or video representing items for sale or navigational aids to other content

A given carrousel can contain presentations corresponding to similar items, such as, for example, the songs for an artist's latest release, or dissimilar but related items, such as all the wallpapers, ring tones, video clips and/or MP3 songs for a particular artist. Because of this, a carrousel can provide multiple ways for selecting a given item, such as, for example, by type (e.g., MP3 song or ring tone), by artist, or by any category the item is listed under.

Within a carrousel presentation, a user is enabled to select one or more of the following exemplary options:
replay a current item;
skip a current item and go to a next item;
rewind to the beginning of a current or previous item;
select an item (e.g., purchase the item, view the item, or go to another sub-carrousel);
return to a previous menu; and/or
request help.

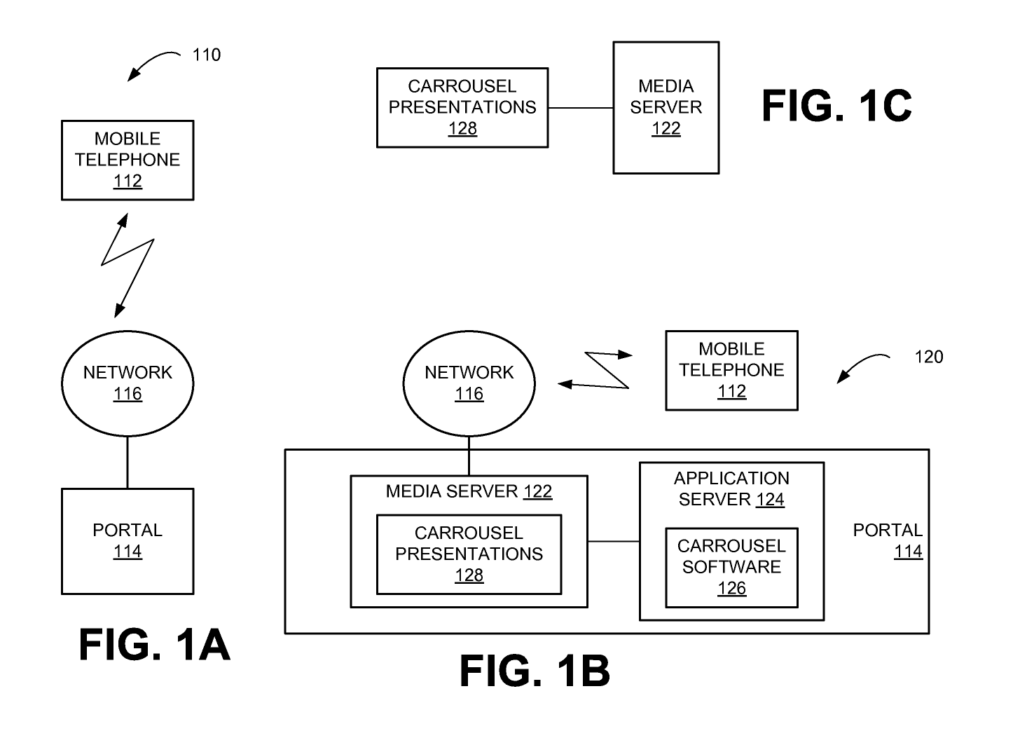

FIG. 1A is a block diagram depicting an embodiment of a communication system 110. The communication system 110 includes a mobile device 112 and a portal 114. The mobile device 112 is coupled to the portal 114 via the communication network 116. The mobile device 112 is, for example, a mobile telephone. The communication network 116 comprises one or more communication networks such as a PSTN (public switched telephone network) and/or a wireless telephone network. The portal 114 provides media carrousels to the mobile device 112 via the communication network 116.

A portal 114 presents content previews to a mobile device user in a sequential loop, allowing the user to pick which content to view (e.g., by pressing a designated key when the preview appears, touching a specific spot on a touch sensitive screen embodiment, speaking a particular word for a voice activated menu embodiment, or otherwise providing a selection indicator). The portal 114 enables the playing of “static” content (e.g., movie clips) and external streams (e.g., web-camera and television feeds) as well as the delivery of other content such as ring tones, games, wallpapers, etc.

The portal 114 enables dynamically loading content and presenting it for browsing and selection by the user. An operator may modify the available content at the portal by loading new content, adding-to or replacing existing content, altering currently available content and/or removing content.

When presentations (video and/or audio) are provided to a user via a carrousel application, the user may select a particular item, skip to the next item, back-up to a previous item, or replay the current item. Selecting an item can lead to the purchase of the item, fulfillment of the item, or to other functionality, including, for example, another carrousel. An application developer can implement any desired number of carrousels to be provided by the portal 114.

The content of a carrousel is dynamic and flexible. A system operator can change all or part of the content of any specific carrousel, thereby increasing or decreasing the number of items in the carrousel. A carrousel application may provide multiple carrousels. Each carrousel can be independent of other carrousels, but can contain links to some of the same items presented by other carrousels. A carrousel is made up of the media items to be displayed in that carrousel. A carrousel configuration file lists the items in that carrousel as well as actions to be taken when a particular item is selected from the carrousel.

The content of a carrousel may also be controlled through an automated process by having a search engine or similar process feed items to or remove items from the carrousel. For instance, the automated process could constantly, periodically or occasionally search for or identify new content to be added to the carrousel or identify out of date or inapplicable items to be removed from the carrousel. Similarly, items in a carrousel may be given a life span and they may automatically be removed upon the expiration of that life span. In addition, the items in a carrousel may be monitored for activity and if the activity pertaining to a certain item does not meet certain parameters (e.g., selected a certain number of times over a period of time) it can be removed. Likewise, items that exceed other thresholds of activity may be used to augment the content of the carrousel. For instance, if a particular item is selected a threshold number of times over a given period of time, similar or related items may be identified and added to the carrousel.

To more specifically illustrate how the concept of the carrousel can be implemented, an exemplary embodiment of the invention is described; however, it should be appreciated that this is simply a non-limiting example. Each of the individual “items” in an exemplary carrousel is in a “ready-to-play” format described, for example, in a media format guide. Each carrousel item, whether it be an end “content” item or a navigational item, comprises a properly formatted video file (e.g., in a.glv format) and/or a corresponding audio file (e.g., in a.glu format). These two files can have the same filename, but with different extensions (e.g.,.glu or.glv) that indicate the respective format. For example, a media clip corresponding to the artist “Samson” is named “SamsonSong1” and has two corresponding media files: “SamsonSong1.glu” (the audio portion of the clip) and “SamsonSong1.glv” (the video portion of the clip). Therefore, a carrousel of 10 items can have 20 associated media files: 10 video files and 10 audio files.

Along with the media files for each exemplary carrousel, there may be a carrousel configuration file (CCF). The CCF has, for example, an XML format, and is used by the portal 114 to load the media into the specified carrousel and to define the behavior of the carrousel when a user is navigating the carrousel. The CCF contains, for example, a carrousel “name”, a space for a carrousel number, and entries for each of the media items in the carrousel.

A carrousel name is an alphanumeric string that is easily readable and understandable by an operator and describes the contents of the respective carrousel. A carrousel that contains movies available during a current week can be named, for example, “ThisWeekMovies.” As another example, a carrousel that contains a collection of items (e.g., wallpapers, songs, videos, etc.) corresponding to the artist “Samson” can be named “SamsonMediaItems.” Once a name is assigned to a carrousel, it can be used as the name of that carrousel indefinitely. A content provider can then update the contents of the carrousel and create a CCF for the carrousel using the assigned carrousel name.

For every item in the exemplary carrousel, there is a set of parameters that define how the item is to be used. Examples of parameters for each item are as follows:
A Content_ID parameter is an alphanumeric string that identifies an item. A Content_ID parameter has a value assigned by a content provider and may have a predetermined maximum number of characters.
A Filename parameter is an alphanumeric string containing the base file name of a clip to be played and the file name of an optional longer version of the clip, if available. For the shorter clip, the portal will append corresponding extensions (e.g., “.glu” and “.glv”), and will search in a default directory for the files to be played. For the longer version, the portal will append different corresponding extensions (e.g., “L.glu” and “L.glv”). A Filename parameter may have a predetermined maximum length (e.g., 20 characters).
A Category parameter is an alphanumeric value assigned by a content provider. A Category parameter represents a corresponding category of content to which an item belongs. A Category parameter can be used for determining whether a user has subscribed to the content selected by a user. The Category parameter also may have a predetermined maximum length and/or specific domain of values.
A Type parameter is used to determine what action to perform when an item is selected by a user. Examples of values for a Type parameter are: WAP_delivery, Play_file, Play_stream, and carrousel. A Type parameter may have a predetermined maximum length (e.g., 20 characters) and/or a specific domain of values.
A Prompt parameter includes a filename of a prompt to be played during a purchase confirmation menu. A Prompt parameter may have a predetermined maximum length (e.g., 20 characters).
A Disable_Skip parameter enables or disables skip forward and backward buttons while a corresponding item is being played. The Disable_Skip parameter has values of, for example, “yes” or “no”. A value of “yes”, will disable the skip forward and backward buttons while a corresponding item is being played. Under most circumstances, the Disable_Skip parameter has a value of “no”.
A Disable_Select parameter enables or disables a select button or action while a corresponding item is being played. The Disable_Select parameter has values of, for example, “yes” or “no”. A value of “yes”, will disable the select button or action while a corresponding item is being played. Under most circumstances, the Disable_Select parameter has a value of “no”.
A Cost parameter is a numeric string identifying a cost of an item in a desired currency. A Cost parameter may have a predetermined maximum length of, for example, 9 characters.
A Rating parameter is a field that identifies or quantifies the characteristics of the content. In the various embodiments this field can be set to a variety of values and levels. For instance, the standard movie ratings schema can be applied (G, PG, R, X) or other rating systems could also be employed. This parameter can be used to filter content from a carrousel accessed by a user or to prevent access to the entire carrousel

An example of a carrousel Configuration File format is as follows:

```
  <carrousel>
  <id> 1 </id>
  <name> NewRelease </name>
  <NumItems> 3 </NumItems>
  <content>
    <content_id> 1234 </content_id>
    <category> 3 </category>
    <filename_base> jinglebell </filename_base>
    <type> play_file </type>
    <prompt> pfile1</prompt>
    <disable_skip> no </disable_skip>
  <disable_select> no </disable_select>
  <charge> 10000 </charge>
  </content>
  <content>
    <content_id> 5678</content_id>
    <category> 2 </category>
    <filename_base> Blackbird </filename_base>
    <type> WAP_deliver </type>
    <prompt> pfile1</prompt>
    <disable_skip> no </disable_skip>
    <disable_select> no </disable_select>
    <charge> 100000 </charge>
  <rating> open </rating>
  </content>
  ...
</carrousel>
```

FIG. 1B is a block diagram depicting an embodiment of a communication system 120. The communication system 120 includes a mobile device 112 and a portal 114. The portal 114 includes a media server 122 and an application server 124. The media server 122 is coupled to the mobile device 112 via a communication network 116. The application server 124 includes the carrousel software 126 which is configured to cause the media server 122 to provide the carrousel presentations 128 to the mobile telephone 112 via the communication network 116. In an alternative embodiment shown in FIG. 1C, the carrousel presentations 128 are stored outside the media server 122.

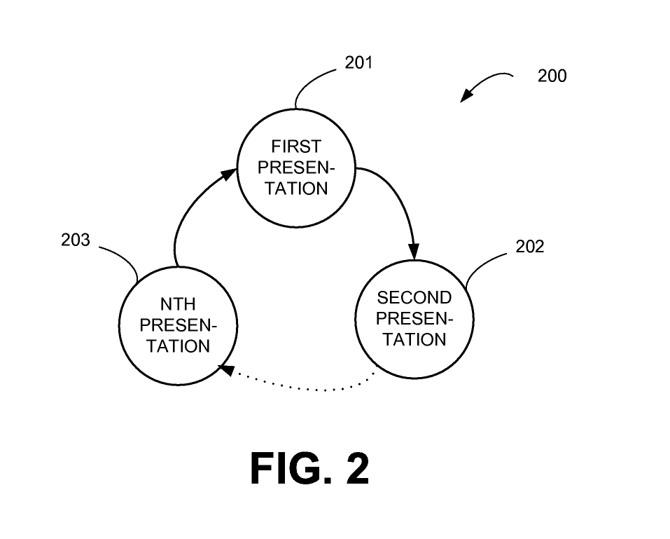

FIG. 2 is a diagram depicting an embodiment of a carrousel 200. The carrousel 200 includes a first presentation 201, a second presentation 202, and an Nth presentation 203. The first presentation 201, the second presentation 202, and the Nth presentation 203 are provided to the mobile device 112 (FIG. 1a) in a repeating cycle until the user selects one of the presentations via the mobile telephone 112. For example, the first presentation 201 is provided first, followed by the second presentation 202, and then followed by any additional presentations in the carrousel 200 until the Nth presentation 203 is presented. If no selection is made by the user, then the cycle is then repeated by providing the first presentation 201 then the second presentation 202, and so on until the user makes a selection. When the user selects a presentation in the carrousel 200, the provision of the carrousel 200 is stopped and media corresponding to the selected presentation is provided to the user. The media provided to the user responsive to the user selection is, for example, a music video, a song, a ring tone or electronic wallpaper.

In another embodiment of the present invention, intelligence can be applied to the operation of the carrousel. For instance, if the user takes no action, the carrousel may operate as described above. However, the carrousel software may be equipped to monitor responses by the user and then alter its operation accordingly. For instance, if the user takes an action to skip an entry in the carrousel, this action may provide useful feedback to the carrousel software for further operations. As a non-limiting example, if the user repeatedly skips or fast forwards through entries that have a certain characteristic, the carrousel software may automatically exclude similar entries from future presentment. More specifically, if the user consistently skips ring tones presentments or songs by a particular artist, the carrousel software may automatically filter such entries from presentment to the user. Likewise, if the user runs through all of the selectable options without making a selection, the carrousel may use alternative content to further solicit actions by the user. For instance, the content may be modified to include different entries or, the content may be expanded for the current entries to include more information.

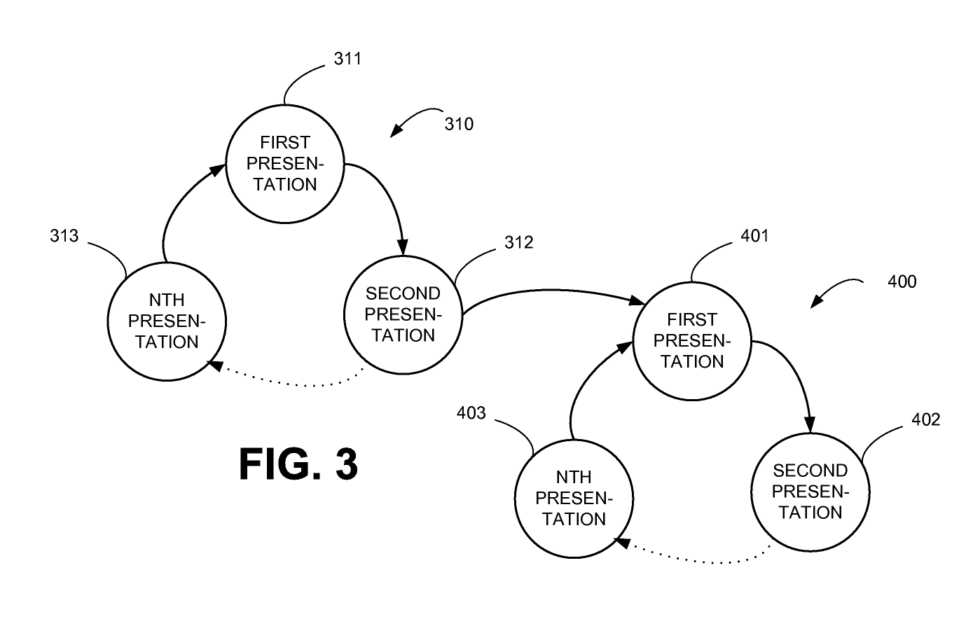

FIG. 3 is a diagram depicting an embodiment of a carrousel system 300. The carrousel system 300 includes a content carrousel 400 and a navigational carrousel 310. The content carrousel 400 and the navigational carrousel 310 operate in a similar manner and can be updated by an operator in a similar manner but provide a user with different types of content. A content carrousel 400 provides entertainment content (e.g., songs, movies, ring tones, etc.), whereas a navigational carrousel 310 provides navigational content (e.g., access to other carrousels).

The content carrousel 400 is typically provided at the end of a selection process where a user is presented with a collection of items related to their interests (e.g., items corresponding to a certain artist). Multiple content carrousels can be used in a carrousel application to group items according to desired categories.

The navigational carrousel 310 contains a list of selectable categories. When the user selects a particular category, another carrousel provides the user with another list of items corresponding to the selected category. For example, a navigational carrousel provides a list of artists. After a user selects an artist, then a content carrousel 400 provides the user with a list of audio and/or video content corresponding to the selected artist.

In this example, the navigational carrousel 310 includes a first presentation 311, a second presentation 312, and an Nth presentation 313. The first presentation 311, the second presentation 312, and the Nth presentation 313 are provided to the mobile device 112 (FIG. 1a) in a repeating cycle until the user selects one of the presentations via the mobile device 112. For example, the first presentation 311 is provided first, followed by the second presentation 312, and then followed by any additional presentations in the navigational carrousel 310 until the Nth presentation 313 is presented. If no selection is made by the user, then the cycle is then repeated by providing the first presentation 311 then the second presentation 312, and so on until the user makes a selection. When the user selects a presentation in the navigational carrousel 310, the provision of the navigational carrousel 310 is stopped and the content carrousel 400 is provided to the user. In an alternative implementation, when the user selects a presentation in the navigational carrousel 310, the user is provided with another navigational carrousel.

The content carrousel 400 includes a first presentation 201, a second presentation 202, and an Nth presentation 203. The first presentation 201, the second presentation 202, and the Nth presentation 203 are provided to the mobile telephone 112 (FIG. 1A) in a repeating cycle until the user selects one of the presentations via the mobile telephone 112. When the user selects a presentation in the content carrousel 400, the provision of the content carrousel 400 is stopped and media corresponding to the selected presentation is provided to the user.

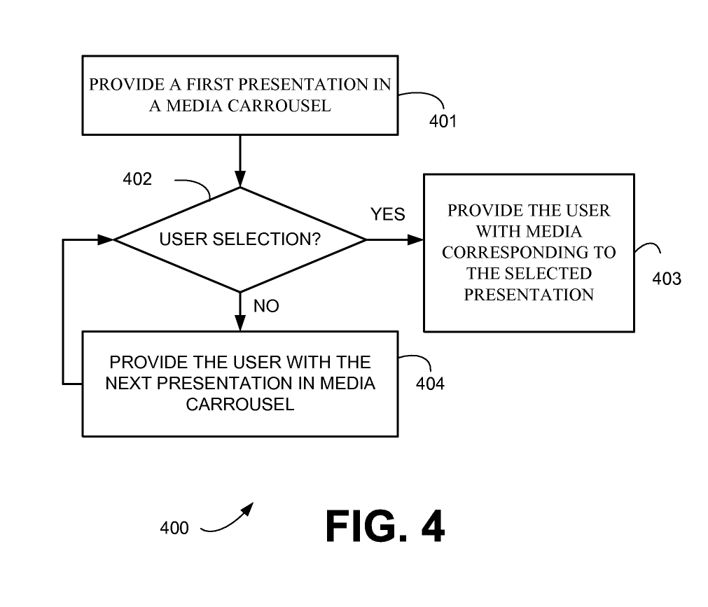

FIG. 4 is a flow chart depicting a method 400 for providing media to a mobile telephone. As indicated in step 401, a user is provided with a first presentation in a media carrousel. If in step 402, a user selects the current media presentation, then the user is provided with media corresponding to the selected presentation, as indicated in step 403. The media provided to the user responsive to the user selection is, for example, a music video, a song, a ring tone or wallpaper.

If in step 402, the user does not select the current media presentation, then the user is provided with the next presentation in the media carrousel, as indicated in step 404. After step 404, the method returns to step 402. Additional presentations are provided to the user in accordance with step 404 until the user makes a selection.

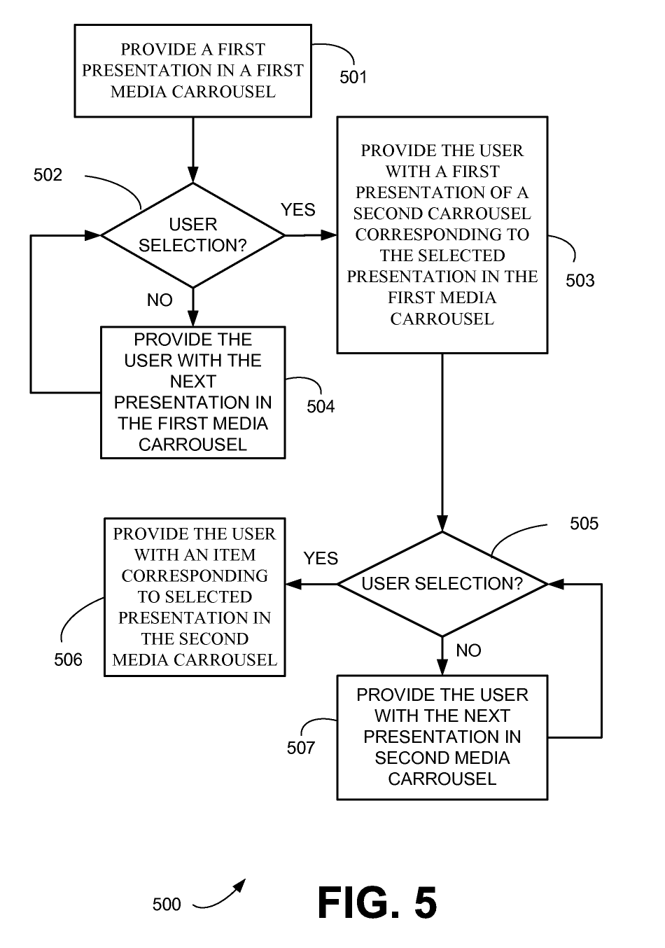

FIG. 5 is a flow chart depicting a method 500 for providing media to a mobile device. A user is provided with a first presentation in a first media carrousel, as indicated in step 501. If in step 502, a user selects a current presentation, then the user is provided with a first presentation of a second media carrousel corresponding to the selected presentation in the first media carrousel, as indicated in step 503, and the method 500 continues to step 505.

If in step 502, the user does not select a current media presentation, then the user is provided with the next presentation in the first media carrousel, as indicated in step 504. After step 504, the method returns to step 502. Additional presentations from the first carrousel are provided to the user in accordance with step 504 until the user makes a selection in step 502.

If in step 505 the user selects a current media presentation in the second media carrousel, then the user is provided with an item corresponding to the selected presentation in the second media carrousel, as indicated in step 506. If in step 505, the user does not select a current media presentation, then the user is provided with the next media presentation in the second media carrousel, as indicated in step 507. After step 507, the method returns to step 505. Additional presentations from the second carrousel are provided to the user in accordance with step 507 until the user makes a selection in step 505.

In an alternative embodiment, the user may be able to navigate back to the first carrousel by actuating a go-back action. It will be appreciated that the carrousel structure may have any number of levels and a user can navigate forward and backward through the various levels of carrousels.

Any process descriptions or blocks in the flow charts should be understood as representing modules, segments, or portions of code which include one or more executable instructions for implementing specific logical functions or steps in the process. Alternative implementations are included within the scope of the embodiments of the invention in which functions are executed out of order from that shown or discussed, including substantially concurrently or in reverse order, depending on the functionality involved, as would be understood by those reasonably skilled in the art of the present invention.

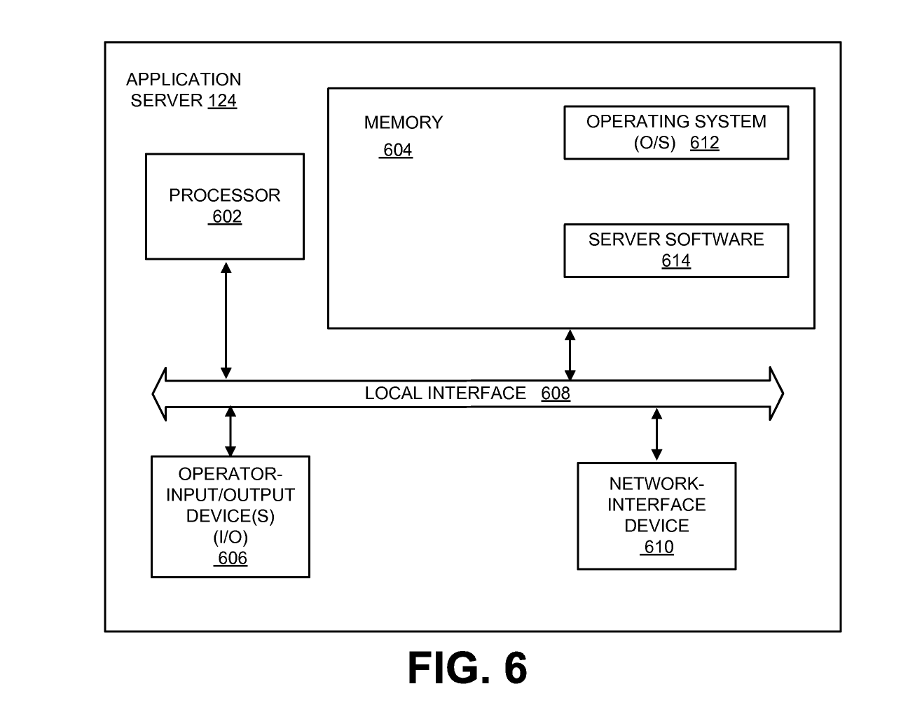

FIG. 6 is a block diagram illustrating an embodiment of an application server 124. The application server 124 includes a processor 602, memory 604 and one or more user input and/or output (I/O) device(s) 606 (or peripherals) that are communicatively coupled via a local interface 608.

The local interface 608 can be, for example but is not limited to, one or more buses or other wired or wireless connections, as is known in the art. The local interface 608 might have additional elements, which are omitted for simplicity, such as controllers, buffers (caches), drivers, repeaters, and receivers, to enable communications. Further, the local interface 608 might include address, control, and/or data connections to enable appropriate communications among the aforementioned components.

The processor 602 is a hardware device for executing software, particularly that stored in memory 604. The processor 602 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 604 can include any one or combination of volatile memory elements (e.g., RAM, such as DRAM, SRAM, SDRAM, etc.) and nonvolatile memory elements (e.g., ROM, flash memory, etc.). Moreover, the memory 604 might incorporate electronic, magnetic, optical, and/or other types of storage media. Note that the memory 604 can have a distributed architecture, where various components are situated remote from one another, but can be accessed by the processor 602.

The user I/O device(s) 606 include input devices such as, for example but not limited to, a keyboard, mouse, scanner, microphone, a touch sensitive display etc. Furthermore, the user I/O device(s) 606 also include output devices such as, for example but not limited to, a printer, display, etc. The network interface device(s) 610 include, for example, a modem, a radio frequency (RF) or other transceiver, a telephonic interface, an Ethernet interface, a bridge, and/or a router.

Software stored in memory 604 may include one or more separate programs, each one of which comprises an ordered listing of executable instructions for implementing logical functions. In the example of FIG. 6, the software in the memory 604 includes operating system 612 and server software 614. Among other things, the operating system 612 essentially controls the execution of the server software 614 and provides scheduling, input-output control, file and data management, memory management, and communication control and related services.

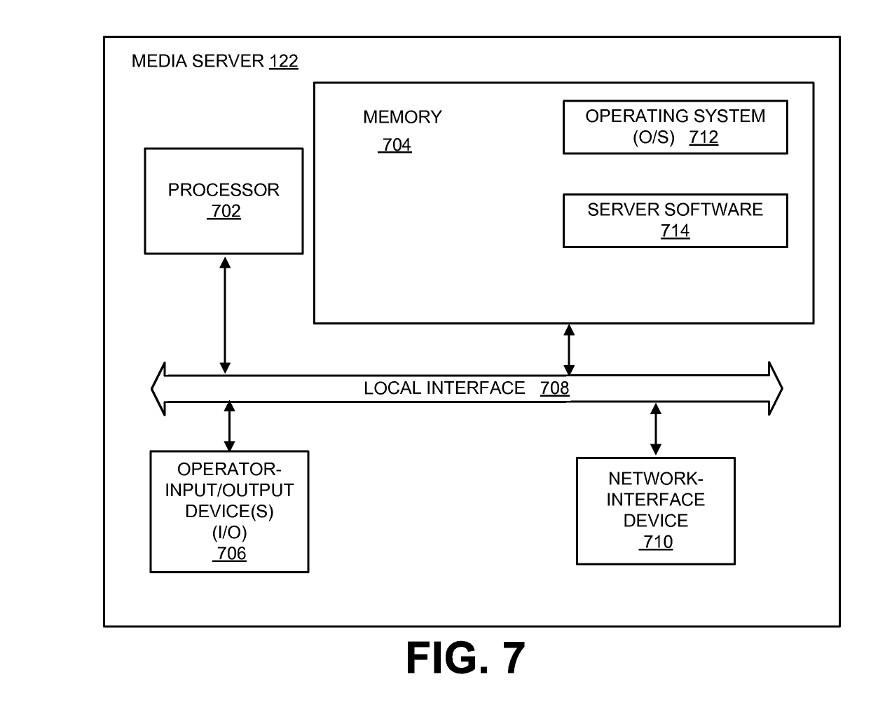

The server software 614 is used by the application server 124 to enable the provision of media carrousels to a mobile telephone 112 (FIG. 1). In one implementation, server software 714 (FIG. 7) provides a media carrousel to a mobile device 112 responsive to receiving a message from the server software 614 requesting the provision of the media carrousel.

The server software 614 is a source program, executable program (object code), script, or any other entity comprising a set of instructions to be performed. When implemented as a source program, the server software 614 is translated via a compiler, assembler, interpreter, or the like, which may or may not be included within the memory 604, so as to operate properly in connection with the O/S 612. Furthermore, the server software 614 can be written in one or more object oriented programming languages, which have classes of data and methods, or procedure programming languages, which have routines, subroutines, and/or functions.

FIG. 7 is a block diagram illustrating an embodiment of a media server 122. The media server 122 includes a processor 702, memory 704 and one or more user input and/or output (I/O) device(s) 706 (or peripherals) that are communicatively coupled via a local interface 708.

The local interface 708 can be, for example but is not limited to, one or more buses or other wired or wireless connections, as is known in the art. The local interface 708 might have additional elements, which are omitted for simplicity, such as controllers, buffers (caches), drivers, repeaters, and receivers, to enable communications. Further, the local interface 708 might include address, control, and/or data connections to enable appropriate communications among the aforementioned components.

The processor 702 is a hardware device for executing software, particularly that stored in memory 704. The processor 702 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 704 can include any one or combination of volatile memory elements (e.g., RAM, such as DRAM, SRAM, SDRAM, etc.) and nonvolatile memory elements (e.g., ROM, flash memory, etc.). Moreover, the memory 704 might incorporate electronic, magnetic, optical, and/or other types of storage media. Note that the memory 704 can have a distributed architecture, where various components are situated remote from one another, but can be accessed by the processor 702.

The user I/O device(s) 706 include input devices such as, for example but not limited to, a keyboard, mouse, scanner, microphone, a touch sensitive display etc. Furthermore, the user I/O device(s) 706 also include output devices such as, for example but not limited to, a printer, display, etc. The network interface device(s) 710 include, for example, a modem, a radio frequency (RF) or other transceiver, a telephonic interface, an Ethernet interface, a bridge, and/or a router.

Software stored in memory 704 may include one or more separate programs, each one of which comprises an ordered listing of executable instructions for implementing logical functions. In the example of FIG. 7, the software in the memory 704 includes operating system 712 and server software 714. Among other things, the operating system 712 essentially controls the execution of the server software 714 and provides scheduling, input-output control, file and data management, memory management, and communication control and related services.

The server software 714 is used by the media server 122 to enable the provision of media carrousels to a mobile telephone 112 (FIG. 1). In one implementation, the server software 714 provides a media carrousel to a mobile telephone 112 responsive to receiving a message from the server software 614 (FIG. 6) requesting the provision of the media carrousel.

The server software 714 is a source program, executable program (object code), script, or any other entity comprising a set of instructions to be performed. When implemented as a source program, the server software 714 is translated via a compiler, assembler, interpreter, or the like, which may or may not be included within the memory 704, so as to operate properly in connection with the O/S 712. Furthermore, the server software 714 can be written in one or more object oriented programming languages, which have classes of data and methods, or procedure programming languages, which have routines, subroutines, and/or functions.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure.

Therefore, having thus described the invention, at least the following is claimed:

1. A method of presenting content to a mobile device, the method comprising the steps of:
outputting a first plurality of media presentations to a mobile device in a first cyclical sequence;
receiving a first user input corresponding to a particular media presentation among the first plurality of media presentations; and
altering the output of the first plurality of media presentations in response to the first user input.

2. The method of claim 1, wherein each of the first plurality of media presentations comprises audio and/or video components and the step of outputting a first plurality of media presentations further comprises rendering the first plurality of media presentations in accordance with the format of the components.

3. The method of claim 1, wherein the first plurality of media presentations comprise one of a music video, a video game, a ring-tone, a digital wallpaper, and a song.

4. The method of claim 1, wherein the step of altering the output of the first plurality of media presentations further comprises:
stopping the output of the first plurality of media presentations; and
outputting a second plurality of media presentations to the mobile device in a second cyclical sequence;

5. The method of claim 1, wherein the step of altering the output of the first plurality of media presentations further comprises:
stopping the output of the first plurality of media presentations; and
outputting media content associated with the particular media presentation.

6. The method of claim 1, wherein the step of altering the output of the first plurality of media presentations further comprises:
stopping the output of the current media presentation;
outputting the next media presentation in the cyclical sequence of media presentations.

7. A method comprising:
transmitting a first plurality of media presentations to a mobile telephone, wherein the first plurality of media presentations are rendered by the mobile telephone in a cyclical sequence at least until a selection signal is detected in association with one of the first plurality of media presentations;
detecting a first selection signal from the mobile telephone, the first selection signal being associated with a first selected media presentation among the first plurality of media presentations; and
transmitting to the mobile telephone alternate media content corresponding to the first selected media presentation among the first plurality of media presentations.

8. The method of claim 7, wherein the alternate media content is a media item selected from the group of media items including a music video, a video game, a ring-tone, a digital wallpaper, and a song.

9. The method of claim 7, wherein the alternate media content is a second plurality of media presentations and the mobile telephone renders the second plurality of media presentations in a cyclical sequence at least until a selection signal is detected in association with one of the second plurality of media presentations.

10. The method of claim 9, further comprising:
detecting a second selection signal from the mobile telephone, the second selection signal being associated with a second selected media presentation among the second plurality of media presentations; and
transmitting to the mobile telephone alternate media content corresponding to the second selected media presentation among the second plurality of media presentations.

11. The method of claim 10, wherein the alternate media content is a media item selected from the group of media items including a music video, a video game, a ring-tone, a digital wallpaper, and a song.

12. The method of claim 10, wherein the alternate media content is a next plurality of media presentations and the mobile telephone renders the next plurality of media presentations in a cyclical sequence at least until a selection signal is detected in association with one of the next plurality of media presentations.

13. The method of claim 7, wherein the alternate media content is a modification of the first plurality of media presentations that is modified in accordance with the first selection signal and the mobile telephone renders the alternate media content.

14. The method of claim 7, one or more of the first plurality of media presentations is automatically modified during a subsequent cyclical sequence presentation of the first plurality of media presentations.

15. A mobile telephone comprising:
software and hardware configured to enable the mobile telephone to:
receive a first plurality of media presentations;
render the first plurality of media presentations in a cyclical sequence at least until a detection of a first selection signal;
detect a first selection signal corresponding to a first selected media presentation among the first plurality of media presentations; and
output at least a first media item corresponding to the first selected media presentation.

16. The mobile telephone of claim 15, wherein each of the first plurality of media presentations comprises audio and video.

17. The mobile telephone of claim 15, wherein the first media item comprises one of a music video, a video game, a ring-tone, a digital wallpaper, and a song.

18. The mobile telephone of claim 15, wherein the software and hardware are further configured to enable the mobile telephone to:
responsive to detecting the first selection signal, rendering a second plurality of media presentations in a cyclical sequence at least until the detection of a second selection signal;
detect a second selection signal corresponding to a second selected media presentation, said second selected media presentation being among the second plurality of media presentations; and
output at least a second media item corresponding to the second selected media presentation responsive to receiving the second user input.

19. The mobile telephone of claim 18, wherein each of the second plurality of media presentations comprises audio and video.

20. The mobile telephone of claim 18, wherein the second media item comprises one of a music video, a video game, a ring-tone, a digital wallpaper, and a song.
